(19) United States
(12) Patent Application Publication
(10) Pub. No.: US 2020/0095705 A1
(43) Pub. Date: Mar. 26, 2020

(54) DEVICE AND METHOD FOR NUCLEIC ACID MANIPULATION

(71) Applicant: Gen9, Inc., Boston, MA (US)

(72) Inventors: Joseph Jacobson, Newton, MA (US); Devin Leake, Lexington, MA (US); Li-Yun A. Kung, Arlington, MA (US)

(73) Assignee: Gen9, Inc., Boston, MA (US)

(21) Appl. No.: 16/615,914

(22) PCT Filed: May 22, 2018
(86) PCT No.: PCT/US2018/033823

§ 371 Date: Nov. 22, 2019

Related U.S. Application Data
(60) Provisional application No. 62/509,426, filed on May 22, 2017.

(51) Int. Cl. C40B 50/14; B01L 3/02; B01J 19/00; C40B 40/06

(52) U.S. Cl. CPC C40B 50/14; B01L 3/0268; B01J 19/0046; C40B 40/06; B01J 2219/00362; B01L 2300/0819; B01J 2219/00529; B01J 2219/00596; B01J 2219/00608; B01J 2219/00711; B01J 2219/00722; B01J 2219/00378

(57) ABSTRACT

Devices and methods are provided for selectively expelling and/or transferring nucleic acids. In one aspect, the device includes a component (e.g., a piezoelectric or an acoustic component) configured to align with one or more features on a solid support, such that when in use, the component (e.g., the piezoelectric or acoustic component) generates a mechanical force to selectively expel and/or transfer one or more volumes of nucleic acid from the solid support. The solid support can include a plurality of discrete features, each feature having a volume (e.g., droplet) of nucleic acid thereon. A power source can be included to provide an electric current to the component (e.g., the piezoelectric or acoustic component, if present) to generate mechanical force. The device can be used for nucleic acid singulation during and/or after assembly.

### CROSS REFERENCE TO RELATED APPLICATIONS

This application claims the benefit under 35 U.S.C. § 119(e) of the filing date of U.S. Provisional Application No. 62/509,426, filed May 22, 2017, the entire contents of which is incorporated by reference herein.

### FIELD

The devices and methods disclosed herein relate to nucleic acid manipulation, particularly during multiplex nucleic acid assembly.

### BACKGROUND

Recombinant and synthetic nucleic acids have many applications in research, industry, agriculture, and medicine. Recombinant and synthetic nucleic acids can be used to express and obtain large amounts of polypeptides, including enzymes, antibodies, growth factors, receptors, and other polypeptides that may be used for a variety of medical, industrial, or agricultural purposes. Recombinant and synthetic nucleic acids also can be used to produce genetically modified organisms including modified bacteria, yeast, mammals, plants, and other organisms. Genetically modified organisms may be used in research (e.g., as animal models of disease, as tools for understanding biological processes, etc.), in industry (e.g., as host organisms for protein expression, as bioreactors for generating industrial products, as tools for environmental remediation, for isolating or modifying natural compounds with industrial applications, etc.), in agriculture (e.g., modified crops with increased yield or increased resistance to disease or environmental stress, etc.), and for other applications. Recombinant and synthetic nucleic acids also may be used as therapeutic compositions (e.g., for modifying gene expression, for gene therapy, etc.) or as diagnostic tools (e.g., as probes for disease conditions, etc.).

Indeed, nucleic acid synthesis is an important area of synthetic biology. According to the U.S. Department of Energy (DOE) in its Report to Congress on dated July 2013, “synthetic biology” is “the design and wholesale construction of new biological parts and systems, and the re-design of existing, natural biological systems for tailored purposes, integrates engineering and computer-assisted design approaches with biological research.” DNA synthesis and assembly have been identified as a fundamental challenge for the continued development of synthetic biology in the DOE report. Specifically, “[o]ne of the major limitations to experimentation in synthetic biology is the synthesis and assembly of large DNA constructs, which remains expensive, slow and error prone. Engineering new bio-production systems would require new approaches for synthesizing and assembling genetic designs rapidly, cheaply, and accurately.”

Numerous techniques have been developed for modifying existing nucleic acids (e.g., naturally occurring nucleic acids) to generate recombinant nucleic acids. For example, combinations of nucleic acid amplification, mutagenesis, nuclease digestion, ligation, cloning and other techniques may be used to produce many different recombinant nucleic acids. Chemically synthesized polynucleotides are often used as primers or adaptors for nucleic acid amplification, mutagenesis, and cloning.

Techniques also are being developed for de novo nucleic acid synthesis on solid supports. For example, single-stranded oligonucleotides of predetermined nucleic acid sequences can be synthesized in situ on a common support wherein each predetermined nucleic acid sequence is synthesized on a separate or discrete feature (or spot) on the support.

Techniques are also available for de novo nucleic acid assembly whereby nucleic acids are made (e.g., chemically synthesized on a support) and assembled to produce longer target nucleic acids of interest. For example, different multiplex assembly techniques are being developed for assembling oligonucleotides into larger synthetic nucleic acids that can be used in research, industry, agriculture, and/or medicine.

However, despite recent developments, one limitation of currently available support-based synthesis and assembly techniques is the ability to identify and select one or more targets of interest. As such, high precision, high selectivity nucleic acid singulation and assembly techniques are needed.

### SUMMARY

In one aspect, a device is provided for selectively expelling and/or transferring nucleic acids that comprises a piezoelectric component configured to align with one or more features on a solid support, such that when in use, the piezoelectric component generates a mechanical force to selectively expel one or more volumes of nucleic acid from the solid support. The solid support comprises a plurality of discrete features, each feature having a volume of nucleic acid thereon or being associated with a volume of nucleic acid. A power source provides an electric current to the piezoelectric component to generate the mechanical force.

In one aspect, a device for selectively expelling nucleic acids is provided, comprising: a) a piezoelectric component configured to align with one or more features on a solid support, such that when in use, the piezoelectric component generates a mechanical force to selectively expel one or more volumes of nucleic acid from the solid support, wherein the solid support comprises a plurality of discrete features, each feature having a volume of nucleic acid thereon or being associated with a volume of nucleic acid; and b) a power source for providing an electric current to the piezoelectric component to generate the mechanical force.

In another aspect, a device for selectively expelling nucleic acids is provided, comprising: (a) a solid support comprising a plurality of discrete features, each feature having a volume of nucleic acid thereon or being associated with a volume of nucleic acid; (b) a piezoelectric component configured to selectively expel one or more volumes of nucleic acid from the solid support; and (c) a power source for providing an electric current to the piezoelectric component to generate a mechanical force to expel the one or more volumes of nucleic acid.

In various embodiments for any of the device disclosed herein, the volume of nucleic acid selectively expelled by the device can comprise one or more oligonucleotides. In various embodiments, the volume of nucleic acid selectively expelled by the device can contain one or more oligonucleotides. The one or more oligonucleotides can be in a dry environment (e.g., associated with a solid bead) or liquid environment (e.g., in an aqueous solution). The one or more oligonucleotides may initially be immobilized (covalently or non-covalently) on one or more features and can be released into the volume of nucleic acid via chemical, enzymatic and/or laser cleavage. In one embodiment, a laser can be used for selectively releasing the one or more oligonucleotides into the volume of nucleic acid by cleaving light-activatable linkers.

In some embodiments, the solid support of the device can have a plurality of oligonucleotides immobilized thereon. For example, each oligonucleotide having a different sequence can be on a discrete, addressable feature. In some embodiments, each feature can contain a plurality of oligonucleotides immobilized thereon. In some embodiments, the solid support can be a microarray or a multiwell plate containing a plurality of beads.

In some embodiments, the piezoelectric component comprises a matrix of piezoelectric elements, wherein each piezoelectric element can be configured to correspond to a feature.

In certain embodiments, the piezoelectric component comprises a single piezoelectric element. In some embodiments, the single piezoelectric element can be a needle. The device can further include a transport component configured to move the needle to a desired feature.

In a further aspect, a method for nucleic acid assembly is provided, comprising: (a) providing a first solid support comprising a plurality of discrete features, each feature having a volume of nucleic acid thereon or being associated with a volume of nucleic acid; (b) selectively expelling (and/or transferring), using a piezoelectric component, one or more volumes of nucleic acid from a first feature to a second feature, wherein the first feature comprises a first oligonucleotide having a sequence complimentary to or overlapping with a second oligonucleotide in the second feature; and (c) assembling the first and second oligonucleotides.

In some embodiments, the piezoelectric component comprises a matrix of piezoelectric elements, wherein each piezoelectric element can be configured to correspond to a feature. In some embodiments, the piezoelectric component comprises a matrix of piezoelectric elements, wherein each piezoelectric element is configured to correspond to a feature. In some embodiments, each volume of nucleic acid comprises one or more oligonucleotides. In some embodiments, each volume of nucleic acid can contain one or more oligonucleotides. The one or more oligonucleotides can be in a dry environment (e.g., associated with a solid bead) or liquid environment (e.g., in an aqueous solution). In some embodiments, each feature can contain a plurality of oligonucleotides immobilized thereon. The one or more oligonucleotides can be released into the volume of nucleic acid via chemical, enzymatic and/or laser cleavage. In some embodiments, the first feature and second feature can be located on the same solid support. In certain embodiments, the first feature can be located on the first solid support and the second feature can be located on a second solid support.

In a further aspect, a device for selectively expelling nucleic acids is provided, comprising: a) a component configured to align with one or more features on a solid support, such that when in use, the component generates a mechanical force to selectively expel one or more volumes of nucleic acid from the solid support, wherein the solid support comprises a plurality of discrete features, each feature being associated with a volume of nucleic acid; and b) a power source for providing an electric current to the component to generate the mechanical force.

In a further aspect, a device for selectively expelling nucleic acids is provided, comprising: a) a solid support comprising a plurality of discrete features, each feature being associated with a volume of nucleic acid; b) a component configured to selectively expel one or more volumes of nucleic acid from the solid support; and c) a power source for providing an electric current to the component to generate a mechanical force to expel the one or more volumes of nucleic acid. In some embodiments, the component is configured to interact with one or more features and effectuate transfer of one or more volumes of nucleic acid through mechanical displacement. In some embodiments, the component is an acoustic component or a piezoelectric component.

In some embodiments, each volume of nucleic acid comprises one or more oligonucleotides. In certain embodiments, the one or more oligonucleotides are in a dry environment or liquid environment. In some embodiments, each volume of nucleic acid is a droplet of solution.

In some embodiments, each feature has a plurality of oligonucleotides immobilized thereon. In certain embodiments, the solid support is a microarray or a multiwell plate comprising a plurality of beads. In some embodiments, the component comprises a matrix of elements, each element configured to correspond to a feature.

In some embodiments, the one or more oligonucleotides are released into the volume of nucleic acid via chemical, enzymatic, and/or laser cleavage.

In some embodiments, the device comprises a laser for selectively releasing the one or more oligonucleotides into the volume of nucleic acid by cleaving light-activatable linkers. In some embodiments, the component comprises a single element. In certain embodiments, the single element is a needle.

In some embodiments, the device comprises a transport component configured to move the needle to a desired feature.

In one aspect, a method of nucleic acid assembly is provided, comprising: a) providing a first solid support comprising a plurality of discrete features, each feature being associated with a volume of nucleic acid; b) selectively expelling, using a component, one or more volumes of nucleic acid from a first feature to a second feature, wherein the first feature comprises a first oligonucleotide having sequence complementarity or overlap with a second oligonucleotide in the second feature; and c) assembling the first and second oligonucleotides. In some embodiments, the component is configured to interact with one or more features and effectuate transfer of one or more volumes of nucleic acid through mechanical displacement. In certain embodiments, the component is an acoustic component or a piezoelectric component. In some embodiments, the component comprises a matrix of elements, each element configured to correspond to a feature.

In certain embodiments, each volume of nucleic acid comprises one or more oligonucleotides. In some embodiments, the one or more oligonucleotides are in a dry environment or liquid environment.

In specific embodiments, the method comprises releasing the one or more oligonucleotides into the volume of nucleic acid via chemical, enzymatic, and/or laser cleavage. In some embodiments, the solid support is a microarray or a multiwell plate comprising a plurality of beads. In certain embodiments, each feature has a plurality of oligonucleotides immobilized thereon.

In some embodiments, the first feature and the second feature are located on the same solid support. In certain embodiments, the first feature is located on the first solid support and the second feature is located on a second solid support.

In a further aspect, a method of nucleic acid assembly, comprising: a) providing a first solid support comprising a plurality of discrete features, each feature being associated with a volume of nucleic acid; b) selectively transferring one or more volumes of nucleic acid from a first feature to a second feature, wherein the first feature comprises a first oligonucleotide having sequence complementarity or overlap with a second oligonucleotide in the second feature; and c) assembling the first and second oligonucleotides.

In some embodiments, each volume of nucleic acid comprises one or more oligonucleotides. In some embodiments, the one or more oligonucleotides are in a dry environment or liquid environment. In certain embodiments, the method further comprises releasing the one or more oligonucleotides into the volume of nucleic acid via chemical, enzymatic, and/or laser cleavage.

In some embodiments, the solid support is a microarray or a multiwell plate comprising a plurality of beads. In some embodiments, each feature has a plurality of oligonucleotides immobilized thereon. In certain embodiments, the first feature and the second feature are located on the same solid support. In specific embodiments, the first feature is located on the first solid support and the second feature is located on a second solid support.

### BRIEF DESCRIPTION OF THE FIGURES

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates, in one embodiment, a two-chip multiplex nucleic acid assembly.

FIG. 2A illustrates an exemplary method for the assembly of an extended oligonucleotide.

FIG. 2B illustrates an exemplary method for the assembly of an extended oligonucleotide.

FIG. 3 illustrates, in one embodiment, fully or partially assembled target nucleic acids and singulation of a selected target nucleic acid.

FIG. 4 illustrates an exemplary method for the assembly of extended oligonucleotide and/or fully or partially assembled target nucleic acids.

FIG. 5 illustrates an exemplary method for the assembly of extended oligonucleotide and/or fully or partially assembled target nucleic acids.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Devices and methods disclosed herein relate to nucleic acid manipulation, particularly during multiplex nucleic acid assembly. In some embodiments, piezoelectric based singulation can be used to selectively pick one or more targets, before, during, and/or after multiplex nucleic acid assembly from, e.g., synthetic oligonucleotides that may have been synthesized and/or immobilized on a solid support. In some embodiments, any method for dissociation of the targets (e.g., aerosol dissociation or liquid dissociation) may be used before, during, and/or after multiplex nucleic acid assembly from, e.g., synthetic oligonucleotides that may have been synthesized and/or immobilized on a solid support (e.g., a microarray, a chip, and/or a bead) with the methods described herein in order to singulate or isolate the targets in respective volumes of nucleic acid. In some embodiments, one or more (e.g., two, three, four, five, six, seven, eight, nine, ten, 20, 25, 30, 35, 40, 45, 50, or more) oligonucleotides from one or more discrete locations (e.g., two, three, four, five, six, seven, eight, nine, ten, 20, 25, 30, 35, 40, 45, 50, or more features or addresses; up to and including all features on a solid support) are dissociated at one time. In certain cases, only selected oligonucleotides are dissociated from a solid support, and other oligonucleotides remain bound. As a non-limiting example, liquid dissociation may be used to dissociate oligonucleotides from the support at selected locations, and these dissociated oligonucleotides may be transferred to another support (a second solid support) or another feature on the same support by any means (e.g., by using piezoelectric or acoustic components, transfer using any means that effects a mechanical displacement, or by transferring using another method such as contact with another solid support).

### Definitions

For convenience, certain terms employed in the specification, examples, and appended claims are collected here. Unless defined otherwise, all technical and scientific terms used herein have the same meaning as commonly understood by one of ordinary skill in the art to which this disclosure belongs.

The articles “a” and “an” are used herein to refer to one or to more than one (i.e., at least one) of the grammatical object of the article. By way of example, “an element” means one element or more than one element.

As used herein, the term “about” means within 20%, more preferably within 10%, and most preferably within 5%. The term “substantially” means more than 50%, preferably more than 80%, and most preferably more than 90% or 95%.

As used herein, “a plurality of” means more than 1, e.g., 2, 3, 4, 5, 6, 7, 8, 9, 10, 11, 12, 13, 14, 15, 16, 17, 18, 19, 20, or more, e.g., 25, 30, 40, 50, 60, 70, 80, 90, 100, 200, 300, 400, 500, or more, or any integer therebetween.

“Assembly” or “assemble” means a process in which short DNA sequences (construction oligonucleotides) are attached in a particular order to form a longer DNA sequence (a target oligonucleotide). “Subassembly,” “subassembly oligonucleotide,” “subconstruct oligonucleotide,” or “subconstruct” means an intermediate step or product where a subset of the construction oligonucleotides are attached to form a subconstruct that is a portion of the final target. “Subassemble” means to create a “subassembly” or “subconstruct” through assembly of a subset of construction oligonucleotides.

“CEL” or “cohesive end ligation” refers to the process of joining DNA fragments in a predesigned order using cohesive ends that are at least partially complementary to one another. The cohesive ends can be generated by restriction enzyme digestion or can be directly synthesized, e.g., on a solid support.

As used herein, a “chip” refers to a DNA microarray with many oligonucleotides attached to a planar surface. The oligonucleotides on a chip can be any length. In some embodiments, the oligonucleotides are about 10-1,000, 20-800, 50-500, 100-300, or about 200 nucleotides, or longer or shorter, or any number or range in between. The oligonucleotides may be single stranded or double stranded.

As used herein, “complementary” or “complementarity” means that two nucleic acid sequences are capable of at least partially base-pairing with one another according to the standard Watson-Crick complementarity rules. For example, two sticky ends can be partially complementary, wherein a region of one overhang complements and anneals with a region or all of another overhang. The gap(s), if any, can be filled in by chain extension in the presence of a polymerase and single nucleotides, followed by or simultaneously with a ligation reaction.

As used herein, a “construct” refers to a DNA sequence which includes a complete target sequence. Generally it is implied that the construct has been assembled. A “subconstruct” means a portion of the complete target sequence that typically is an intermediate product during hierarchical assembly.

As used herein, a “feature” refers to a discrete location (or spot) on a solid support, e.g., a chip, multiwell tray, or microarray. In some embodiments, oligonucleotides can be synthesized on and/or immobilized to the feature. An arrangement of discrete features can be presented on the solid support for storing, routing, amplifying, releasing and otherwise manipulating oligonucleotides or complementary oligonucleotides for further reactions. In some embodiments, each feature is addressable; that is, each feature is positioned at a particular predetermined, prerecorded location (i.e., an “address”) on the support. Therefore, each oligonucleotide is localized to a known and defined location on the support. The sequence of each oligonucleotide can be determined from its position on the support. The size of the feature can be chosen to allow formation of a microvolume (e.g., 1-1000 microliters, 1-1000 nanoliters, or 1-1000 picoliters) droplet on the feature, each droplet being kept separate from each other. As used herein, features are typically, but need not be, separated by interfeature spaces to ensure that droplets between two adjacent features do not merge. Interfeatures will typically not carry any oligonucleotide on their surface and will correspond to inert space. In some embodiments, features and interfeatures may differ in their hydrophilicity or hydrophobicity properties.

As used herein, “nucleic acid,” “nucleic acid sequence,” “oligonucleotide,” “polynucleotide,” “gene” or other grammatical equivalents as used herein means at least two nucleotides, either deoxyribonucleotides or ribonucleotides, or analogs thereof, covalently linked together. Polynucleotides are polymers of any length, including, e.g., 10, 20, 50, 100, 200, 300, 500, 1000, etc., but are not limited to these specific examples. As used herein, an “oligonucleotide” may be a nucleic acid molecule comprising at least two covalently bonded nucleotide residues. In some embodiments, an oligonucleotide may be between 10 and 1,000 nucleotides long. For example, an oligonucleotide may be between 10 and 500 nucleotides long, or between 500 and 1,000 nucleotides long. In some embodiments, an oligonucleotide may be between about 20 and about 800 nucleotides long (e.g., from about 20 to 400, from about 400 to 800 nucleotides long). In some embodiments, an oligonucleotide may be between about 50 and about 500 nucleotides long (e.g., from about 50 to 250 nucleotides long or from about 250 to 500 nucleotides long). In some embodiments, an oligonucleotide may be between about 100 and about 300 nucleotides long (e.g., from about 100 to 150 nucleotides long or from about 150 to 300 nucleotides long). However, shorter or longer oligonucleotides may be used. An oligonucleotide may be a single-stranded or double-stranded nucleic acid. As used herein the terms “nucleic acid,” “polynucleotide,” and “oligonucleotide” are used interchangeably and refer to naturally-occurring or non-naturally occurring, synthetic polymeric forms of nucleotides. In general, the term “nucleic acid” includes both “polynucleotide” and “oligonucleotide” where “polynucleotide” may refer to a longer nucleic acid (e.g., more than 1,000 nucleotides, more than 5,000 nucleotides, more than 10,000 nucleotides, etc.) and “oligonucleotide’ may refer to a shorter nucleic acid (e.g., 10-500 nucleotides, 20-400 nucleotides, 40-200 nucleotides, 50-100 nucleotides, etc.).

The nucleic acid molecules of the present disclosure may be formed from naturally occurring nucleotides, for example forming deoxyribonucleic acid (DNA) or ribonucleic acid (RNA) molecules. Alternatively, nucleic acids may include structural modifications to alter their properties, such as in peptide nucleic acids (PNA) or in locked nucleic acids (LNA). The solid phase synthesis of nucleic acid molecules with naturally occurring or artificial bases is well known in the art. The terms should be understood to include equivalents, analogs of either RNA or DNA made from nucleotide analogs and as applicable to the embodiment being described, single-stranded or double-stranded polynucleotides. Nucleotides useful in the disclosure include, for example, naturally-occurring nucleotides (for example, ribonucleotides or deoxyribonucleotides), natural or synthetic modifications of nucleotides, and artificial bases. In some embodiments, the sequence of the nucleic acids does not exist in nature (e.g., a cDNA or complementary DNA sequence, or an artificially designed sequence).

Nucleosides in a nucleic acid nucleosides may be linked by phosphodiester bonds. Whenever a nucleic acid is represented by a sequence of letters, it will be understood that the nucleosides are in the 5′ to 3′ order from left to right. In accordance to the IUPAC notation, “A” denotes adenine, “C” denotes cytosine, “G” denotes guanine, “T” denotes thymine, and “U” denotes the ribonucleoside, uridine. In addition, there are also letters which are used when more than one kind of nucleotide could occur at that position: “W” (i.e. weak interaction; 2H bonds) represents A or T, “S” (strong interaction; 3H bonds) represents G or C, “M” (for amino) represents A or C, “K” (for keto) represents G or T, “R” (for purine) represents A or G, “Y” (for pyrimidine) represents C or T, “B” represents C, G or T, “D” represents A, G, or T, “H” represents A, C, or T, “V” represents A, C, or G, and “N” represents any base A, C, G, or T (U). It is understood that nucleic acid sequences are not limited to the four natural deoxynucleotides but can also comprise ribonucleosides and non-natural nucleotides. A “I” in a nucleotide sequence or nucleotides given in brackets refer to alternative nucleotides, such as alternative U in a RNA sequence instead of T in a DNA sequence. Thus, U/T or U(T) indicate one nucleotide position that can either be U or T. Likewise, A/T refers to nucleotides A or T; G/C refers to nucleotides G or C. Due to the functional identity between U and T any reference to U or T herein shall also be seen as a disclosure as the other one of T or U. For example, the reference to the sequence UUCG (on an RNA) shall also be understood as a disclosure of the sequence TTCG (on a corresponding DNA). For simplicity only, only one of these options is described herein. Complementary nucleotides or bases are those capable of base pairing such as A and T (or U); G and C; or G and U (wobble base pairing).

As used herein, “piezoelectric component” or “piezoelectric elements” refers to a device or portion of a device that makes use of piezoelectric propulsion to generate the mechanical force required to move a volume of nucleic acid from one location to another. In some embodiments, the mechanical force so generated may be sufficient to cleave a target nucleic acid at a cleavable linker by which it is attached to a solid support. Generally speaking, certain crystals or ceramics exhibit a property through which they may generate an electric field in the presence of a mechanical force. These materials may also undergo a reverse piezoelectric effect whereby they generate internal mechanical strain resulting from an applied electric field. It is the latter effect that is used for nucleic acid ejection. The piezoelectric component can be in the form of a board, a grid, or a matrix of piezoelectric elements. The piezoelectric component can also be in the form of a single piezoelectric element, such as a nozzle or needle.

As used herein, the terms “solid support”, “support,” and “substrate” are used interchangeably and refer to a porous or non-porous solid (e.g., solvent insoluble) material on which polymers such as nucleic acids are synthesized or immobilized. As used herein “porous” means that the material contains pores having substantially uniform diameters (for example in the nm range). Porous materials can include but are not limited to, paper, synthetic filters, and the like. In such porous materials, the reaction may take place within the pores. The support can have any one of a number of shapes, such as pin, strip, plate, disk, rod, bends, cylindrical structure, or particle (including, but not limited to, beads, nanoparticles and the like). In some embodiments, the support is planar (e.g., a chip). The support can have variable widths. The solid support can be an organized matrix or network of wells, such as a microarray. In some embodiments, the support can include a plurality of beads or particles, optionally positioned in one or more multiwall plates.

The support can be hydrophilic or capable of being rendered hydrophilic. The support can include, but is not limited to: inorganic powders such as silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly (4-methylbutene), polystyrene, polymethacrylate, poly(ethylene terephthalate), nylon, poly(vinyl butyrate), polyvinylidene difluoride (PVDF) membrane, glass, controlled pore glass, magnetic controlled pore glass, ceramics, metals, and the like; either used by themselves or in conjunction with other materials such as, but not limited to, those listed herein.

As used herein, the term “array” refers to an arrangement of discrete features for storing, routing, amplifying and releasing oligonucleotides or complementary oligonucleotides for further reactions. The array can be planar. In an embodiment, the support or array can be addressable. Addressable supports or arrays may enable the direct control of individual isolated volumes such as droplets.

As used herein, the term “immobilized” refers to oligonucleotides bound to a solid support that may be attached through their 5′ end or 3′ end. The support-bound oligonucleotides may be immobilized on the chip via a nucleotide sequence (e.g., degenerate binding sequence) or linker (e.g., a light-activatable linker or chemical linker). It should be appreciated that by 3′ end, it is meant the sequence downstream to the 5′ end and by 5′ end it is meant the sequence upstream to the 3′ end. For example, an oligonucleotide may be immobilized on the chip via a nucleotide sequence or linker that is not involved in subsequent reactions. Certain immobilization methods are reviewed by Nimse et al., Sensors 2014, 14, 22208-22229, the disclosure of which is incorporated herein by reference in its entirety.

As used herein, the term “chemical cleavage” refers to the release of an immobilized oligonucleotide by cleaving or degrading a labile linkage susceptible to chemical cleavage or degradation, thus freeing the immobilized oligonucleotide. For example, a region of the linkage can contain a region that is chemically modified to hydrolyze or degrade in response to changes in the pH of the local environment. Certain chemically-cleavable linkers are reviewed by Leriche et al., Bioorganic and Medicinal Chemistry 20 (2012) 571-582, the disclosure of which is incorporated herein by reference in its entirety. As a non-limiting example, oligonucleotides may be released from one or more features on a solid support by the hydrolytic cleavage of a P—O bond that attaches the 3′-O of the 3′-terminal nucleotide residue to the universal linker using gaseous ammonia, aqueous ammonium hydroxide, aqueous methylamine, or their mixture.

As used herein, the term “enzymatic cleavage” refers to the release of an immobilized oligonucleotide by cleaving or degrading a labile linkage containing a region susceptible to enzymatic degradation, thus freeing the immobilized oligonucleotide. Exemplary cleavable groups include but are not limited to peptidic sequences cleavable by proteases such as TEV protease, trypsin, thrombin, cathepsin B, cathespin D, cathepsin K, caspase 1, and matrix metalloproteinase, as well as groups such as phosphodiester, phospholipid, ester, and β-galactose groups. Certain enzyme-cleavable linkers are reviewed by Leriche et al., Bioorganic and Medicinal Chemistry 20 (2012) 571-582, the disclosure of which is incorporated herein by reference in its entirety. In addition, the linkage can contain a nucleic acid sequence susceptible to cleavage by restriction enzymes. Examples of restriction enzyme cleavage sites include, but are not limited to, those recognizable by common restriction enzymes such as AatI, AatII, AccI, AfIII, AIuI, AIw44I, ApaI, AseI, AvaI, BamHI, BanI, BanII, BanIII, BbrPI, MI, BfrI, BglI, BgIII, BsiWI, BsmI, BssHII, BstEII, BstXI, Cfr9I, Cfr10I, Cfr13I, CspI, Csp45I, DdeI, DraI, Eco47I, Eco47III, Eco52I, Eco81I, Eco105I, EcoRI, EcoRII, EcoRV, EcoT22I, EheI, FspI, HaeII, HaeIII, HhaI, HinII, HincII, HindIII, HinfI, HpaI, HpaII, KpnI, MboII, MIuI, MroI, MscI, MspI, MvaI, NaeI, NarI, NciI, NcoI, NheI, NotI, NruI, NspV, PacI, PpuMI, PstI, PvuI, PvuII, RsaI, SacI, SacII, SaII, Sau3AI, Sau96I, ScaI, ScrFI, SfiI, SmaI, SpeI, SphI, SrfI, SspI, TaqI, TspEI, XbaI, and XhoI. Other restriction enzymes known in the field may also be used.

As used herein, the term “cleavage of a light-activatable linker” refers to the release of an immobilized oligonucleotide by cleaving or degrading a labile linkage susceptible to light and/or heat from the light, such as a laser, thus freeing the immobilized oligonucleotide. For example, a region of the linkage can be degraded by heat as a result of the application of a laser to the linkage. Other light- or photo-cleavable groups include 2-Nitrobenzyl derivatives, phenacyl ester, 8-quinolinyl benzenesulfonate, coumarin, phosphotriester, bis-arylhydrazone, and bimane bi-thiopropionic acid derivatives. Certain light-activatable linkers are reviewed by Leriche et al., Bioorganic and Medicinal Chemistry 20 (2012) 571-582, the disclosure of which is incorporated herein by reference in its entirety.

A “target” or “target oligonucleotide” means a nucleic acid of a known nucleotide sequence (e.g., as ordered by a customer) to be identified, synthesized, and/or assembled using one or more methods disclosed herein. According to some embodiments, the target nucleic acid sequence can be designed and/or analyzed in a computer-assisted manner to generate a set of parsed double-stranded or single-stranded oligonucleotides. As used herein, the term “parsed” means that a sequence of the target nucleic acid has been delineated, for example in a computer-assisted manner, so as to identify a series of adjacent, contiguous construction fragments that together comprise the target nucleic acid. Adjacent construction fragments can be single-stranded or double-stranded, and can overlap with one another by an appropriate number (e.g., 3-20, 3-30, 3-40, 3-50, 4-20, 4-30, 4-40, 4-50, 5-20, 5-30, 5-40, 5-50, or another appropriate number) of nucleotides to facilitate assembly.

As used herein, “including,” “comprising,” “having,” “containing,” “involving,” and variations thereof, are meant to encompass the items listed thereafter and equivalents thereof as well as additional items. “Consisting of” shall be understood as a close-ended relating to a limited range of elements or features. “Consisting essentially of” limits the scope to the specified elements or steps but does not exclude those that do not materially affect the basic and novel characteristics of the claimed invention.

As used herein, the term “singulation” may refer to the identification and/or isolation of a molecule or set of essentially identical molecules (e.g., oligonucleotide(s)). The term “singulation” may also refer to the process of or state of being able to identify and/or isolate a single molecule or set of essentially identical molecules (e.g., oligonucleotide(s)).

As used herein, the term “volume of nucleic acid” refers to a homologous or heterologous group of oligonucleotides at a specific (discrete) location or feature. A volume of nucleic acid may be “wet” (i.e., may comprise one or more liquid elements including, but not limited to, one or more buffer solutions and/or water) or may be dry (i.e., does not comprise a liquid element). Multiple volumes of nucleic acid will be present at a respective number of specific (discrete) locations or features. As a non-limiting example, three volumes of nucleic acid would be present at three specific (discrete) locations or features, with one volume of nucleic acid present at each of the three specific (discrete) locations or features.

Other terms used in the fields of recombinant nucleic acid technology, synthetic biology, and molecular biology as used herein will be generally understood by one of ordinary skill in the applicable arts.

### Synthetic Oligonucleotides

Synthetic oligonucleotides can be used in multiplex nucleic acid assembly as construction oligonucleotides. To assemble a target nucleic acid, one strategy is to analyze the sequence of the target nucleic acid and parse it into two or more construction oligonucleotides that can be assembled (e.g., ligated) into the target nucleic acid.

In some embodiments, one or more construction oligonucleotides can be amplified before assembly. To facilitate amplification, one or more construction oligonucleotides and/or subconstructs may be designed to comprise one or more primer biding sites to which a primer can bind or anneal in a polymerase chain reaction. The primer biding sites can be designed to be universal (i.e., the same) to all construction oligonucleotides or a subset thereof, or two or more subconstructs. Universal primer biding sites (and corresponding universal primers) can be used to amplify all construction oligonucleotides or subconstructs having such universal primer biding sites in a polymerase chain reaction. Primer binding sites that are specific to one or more select construction oligonucleotides and/or subconstructs can also be designed, so as to allow targeted, specific amplification of the select construction oligonucleotides and/or subconstructs. In some embodiments, all of the primer binding sites are unique. In some embodiments, one or more construction oligonucleotides and/or subconstructs may contain nested or serial primer binder sites at one or both ends where one or more outer primers and inner primers can bind. In one example, the construction oligonucleotides and/or subconstructs each have binding sites for a pair of outer primers and a pair of inner primers. One or both of the pair of outer primers may be universal primers. Alternatively, one or both of the pair of outer primers may be unique primers. In some embodiments, before assembly, each of the construction oligonucleotides is individually amplified. The construction oligonucleotides can also be pooled into one or more pools for amplification. In one example, all of the construction oligonucleotides are amplified in a single pool. In certain embodiments, the amplified construction oligonucleotides are assembled via polymerase based assembly or ligation. The amplified construction oligonucleotides may be assembled hierarchically or sequentially or in a one-step reaction into the target nucleic acid.

One or more of the primer binding sites can be designed to be part of the construction oligonucleotides that are incorporated into the final target nucleic acid. In some embodiments, all or part of each primer binding site can be in the form of a flanking region outside the central portion of a construction oligonucleotide, wherein the central portion is incorporated into the final target nucleic acid and the flanking region needs be removed before assembly. To that end, one or more restriction enzyme (RE) sites can be designed to allow removal of the flanking region.

In some embodiments, the RE sites can be a type II RE sites such as type IIP or IIS and modified or hybrid sites. Type IIP enzymes recognize symmetric (or palindromic) DNA sequences 4 to 8 base pairs in length and generally cleave within that sequence. Non-limiting examples of type IIP restriction enzymes include: EcoRI, HindIII, BamHI, NotI, PacI, MspI, HinP1I, BstNI, NciI, SfiI, NgoMIV, EcoRI, HinfI, Cac8I, AlwNI, PshAI, BglI, XcmI, HindIII, NdeI, SacI, PvuI, EcoRV, NciI, TseI, PspGI, BglII, ApoI, AccI, BstNI, and NciI. Type IIS restriction enzymes make a single double stranded cut 0-20 bases away from the recognition site. Non-limiting examples of type IIS restriction enzymes include: BstF5I, BtsCI, BsrDI, BtsI, AlwI, BccI, BsmAI, EarI, MlyI (blunt), PleI, BmrI, BsaI, BsmBI, FauI, MnlI, SapI, BbsI, BciVI, HphI, MboII, BfuAI, BspCNI, BspMI, SfaNI, HgaI, BseRI, BbvI, EciI, FokI, BceAI, BsmFI, BtgZI, BpuEI, BsgI, MmeI, BseGI, Bse3DI, BseMI, AcIWI, Alw26I, Bst6I, BstMAI, Eam1104I, Ksp632I, PpsI, SchI (blunt), BfiI, Bso31I, BspTNI, Eco31I, Esp3I, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, and BcgI. Such enzymes and information regarding their recognition and cleavage sites are available from commercial suppliers such as New England Biolabs, Inc. (Ipswich, Mass., U.S.A.).

The restriction enzyme (RE) sites can be methylated such that they can be digested with a methylation-sensitive nuclease such as MspJI, SgeI, and/or FspEI. Such a methylation-sensitive nuclease shares both type IIM and type IIS properties; thus, it only recognizes the methylation-specific 4-bp sites, ^{m}CNNR (N=A or T or C or G; R=A or G), and cuts DNA outside of this recognition sequence.

Following design of the construction oligonucleotides based on the target nucleic acid, construction oligonucleotides can be synthesized or otherwise supplied by commercial vendors or any methods known in the art. Typically, oligonucleotide synthesis involves a number of chemical steps that are performed in a cyclical or repetitive manner throughout the synthesis with each cycle adding one nucleotide to the growing oligonucleotide chain. The chemical steps involved in a cycle are a deprotection step that liberates a functional group for further chain elongation, a coupling step that incorporates a nucleotide into the oligonucleotide to be synthesized, and other steps as required by the particular chemistry used in the oligonucleotide synthesis, such as e.g. an oxidation step required with the phosphoramidite chemistry. Optionally, a capping step that blocks those functional groups which were not elongated in the coupling step can be inserted in the cycle. The nucleotide can be added to the 5′-hydroxyl group of the terminal nucleotide, in the case in which the oligonucleotide synthesis is conducted in a 3′→5′ direction or at the 3′-hydroxyl group of the terminal nucleotide in the case in which the oligonucleotide synthesis is conducted in a 5′→3′ direction.

For clarity, the two complementary strands of a double stranded nucleic acid are referred to herein as the positive (P) and negative (N) strands. This designation is not intended to imply that the strands are sense and anti-sense strands of a coding sequence. They refer only to the two complementary strands of a nucleic acid (e.g., a target nucleic acid, an intermediate nucleic acid fragment, etc.) regardless of the sequence or function of the nucleic acid. Accordingly, in some embodiments the P strand may be a sense strand of a coding sequence, whereas in other embodiments the P strand may be an anti-sense strand of a coding sequence. It should be appreciated that the reference to complementary nucleic acids or complementary nucleic acid regions herein refers to nucleic acids or regions thereof that have sequences which are reverse complements of each other so that they can hybridize in an antiparallel fashion typical of natural DNA.

In some aspects of the disclosure, the oligonucleotides synthesized or otherwise prepared according to the methods described herein can be used as building blocks for the assembly of a target polynucleotide or oligonucleotide of interest (e.g., of a predetermined or predefined sequence).

Oligonucleotides may be synthesized on solid support using methods known in the art. In some embodiments, pluralities of different single-stranded oligonucleotides are immobilized at different features of a solid support. In some embodiments, the support-bound oligonucleotides may be attached through their 5′ end or their 3′ end. In some embodiments, the support-bound oligonucleotides may be immobilized on the support via a nucleotide sequence (e.g. degenerate binding sequence) or a linker (e.g. a photocleavable linker or chemical linker). It should be appreciated that by 3′ end, it is meant the sequence downstream to the 5′ end and by 5′ end it is meant the sequence upstream to the 3′ end. For example, an oligonucleotide may be immobilized on the support via a nucleotide sequence or linker that is not involved in subsequent reactions.

Certain embodiments of the disclosure may make use of a solid support comprised of an inert substrate and a porous reaction layer. The porous reaction layer can provide a chemical functionality for the immobilization of pre-synthesized oligonucleotides or for the synthesis of oligonucleotides. In some embodiments, the surface of the array can be treated or coated with a material comprising suitable reactive group for the immobilization or covalent attachment of nucleic acids. Any material known in the art and having suitable reactive groups for the immobilization or in situ synthesis of oligonucleotides can be used.

In some embodiments, the porous reaction layer can be treated so as to comprise hydroxyl reactive groups. For example, the porous reaction layer can comprise sucrose.

According to some aspects of the disclosure, oligonucleotides terminated with a 3′ phosphoryl group oligonucleotides can be synthesized a 3′→5′ direction on a solid support having a chemical phosphorylation reagent attached to the solid support. In some embodiments, the phosphorylation reagent can be coupled to the porous layer before synthesis of the oligonucleotides. In an exemplary embodiment, the phosphorylation reagent can be coupled to the sucrose. For example, the phosphorylation reagent can be 2-[2-(4,4′-Dimethoxytrityloxy)ethylsulfonyl]ethyl-(2-cyanoethyl)-(N,N-diisopropyl)-phosphoramidite. In some embodiments, the 3′ phosphorylated oligonucleotide can be released from the solid support and undergo subsequent modifications according to the methods described herein. In some embodiments, the 3′ phosphorylated oligonucleotide may be released using aerosol dissociation or liquid dissociation. In some embodiments, the 3′ phosphorylated oligonucleotide can be released from the solid support using gaseous ammonia, aqueous ammonium hydroxide, aqueous methylamine, or a mixture of two or more of these components.

In some embodiments, synthetic oligonucleotides for the assembly may be designed (e.g. having a designed or predetermined sequence, size, and/or number). Synthetic oligonucleotides can be generated using standard DNA synthesis chemistry (e.g. through use of the phosphoramidite method). Synthetic oligonucleotides may be synthesized on a solid support including, but not limited to, a microarray, using any appropriate technique as described in more detail herein. Oligonucleotides can be eluted from the microarray prior to being subjected to amplification or can be amplified on the microarray. It should be appreciated that different oligonucleotides may be designed to have different lengths.

In some embodiments, oligonucleotides are synthesized (e.g., on an array format) as described in U.S. Pat. No. 7,563,600, U.S. patent application Ser. No. 13/592,827, and/or PCT/US2013/047370 published as WO 2014/004393, which are hereby incorporated by reference in their entireties. For example, single-stranded oligonucleotides may be synthesized in situ on a common support wherein each oligonucleotide (e.g., an individual oligonucleotide of a given sequence or more than one oligonucleotide of the same sequence) is synthesized on a separate or discrete feature (or spot) on the substrate. In some embodiments, single-stranded oligonucleotides are bound to the surface of the support or feature. As used herein, the term “array” refers to an arrangement of discrete features for storing, routing, amplifying and releasing oligonucleotides or complementary oligonucleotides for further reactions. The array can be planar. In an embodiment, the support or array is addressable: the support includes two or more discrete addressable features at a particular predetermined location (i.e., an “address”) on the support. Therefore, each oligonucleotide molecule of the array is localized to a known and defined location on the support. The sequence of each oligonucleotide can be determined from its position on the support. In some embodiments, each feature (defined location on the support) may have more than one oligonucleotide, but only when each oligonucleotide at that feature has the same sequence. Moreover, addressable supports or arrays enable the direct control of individual isolated volumes such as droplets. The size of the defined feature can be chosen to allow formation of a microvolume droplet on the feature, each droplet being kept separate from each other. As described herein, features are typically, but need not be, separated by interfeature spaces to ensure that droplets between two adjacent features do not merge. Interfeatures will typically not carry any oligonucleotide on their surface and will correspond to inert space. In some embodiments, features and interfeatures may differ in their hydrophilicity or hydrophobicity properties.

An oligonucleotide may be a single-stranded nucleic acid. However, in some embodiments a double-stranded (at least in part) oligonucleotide may be used as described herein. In certain embodiments, an oligonucleotide may be chemically synthesized as described herein. In some embodiments, synthetic oligonucleotide may be amplified before use. The resulting product may be double stranded.

One or more modified bases (e.g., a nucleotide analog) can be incorporated. Examples of modifications include, but are not limited to, one or more of the following: methylated bases such as cytosine and guanine; universal bases such as nitro indoles, dP and dK, inosine, uracil; halogenated bases such as BrdU; fluorescent labeled bases; non-radioactive labels such as biotin (as a derivative of dT) and digoxigenin (DIG); 2,4-Dinitrophenyl (DNP); radioactive nucleotides; post-coupling modification such as dR-NH2 (deoxyribose-NEb); Acridine (6-chloro-2-methoxiacridine); and spacer phosphoramides which are used during synthesis to add a spacer “arm” into the sequence, such as C3, C8 (octanediol), C9, C12, HEG (hexaethlene glycol) and C18.

In various embodiments, the synthetic single-stranded or double-stranded oligonucleotides can be non-naturally occurring. In some embodiments, the synthetic oligonucleotides may be unmethylated or modified in such a way (e.g., chemically or biochemically modified in vitro) that they become hemi-methylated (only one strand is methylated), semi-methylated (only a portion of the normal methylation sites are methylated on one or both strands), hypomethylated (more than the normal methylation sites are methylated on one or both strands), or otherwise have non-naturally occurring methylation patterns (some of the normal methylation sites are methylated on one or both strands and/or normally unmethylated sites are methylated). In contrast, naturally-occurring DNA typically contains epigenetic modifications such as methylation at, e.g., the C-5 position of the cytosine ring of DNA by DNA methyltransferases (DNMTs) in vivo. DNA methylation is reviewed by Jin et al., Genes & Cancer 2011 June; 2(6): 607-617, which is incorporated herein by reference in its entirety.

### Multiplex Nucleic Acid Assembly

Multiplex nucleic acid assembly can be used to prepare one or more target nucleic acids, wherein for each target, multiple construction oligonucleotides can be brought into contact with one another according to a predesigned order. The construction oligonucleotides can be single stranded and may, by design, alternate between positive and negative strands such that one construction oligonucleotide partially anneals with the next construction oligonucleotide and together form a double-stranded (at least in part) product. The construction oligonucleotides can also be double stranded and be designed to have compatible cohesive ends that at least partially anneal with one another to align the construction oligonucleotides in a predesigned order to form a double-stranded product. The double-stranded product may be gap free and produce the target nucleic acid upon ligation. The double-stranded product may contain gaps that can be filled in by a polymerase.

In some embodiments, assembly may occur in a parallel fashion where multiple target nucleic acids are prepared simultaneously. For example, 2-100,000, 5-10,000, 10-1000, 100-500, or any other number of targets can be produced in parallel.

Assembly can be carried out using hierarchical, sequential and/or one-step assembly. By way of example only, hierarchical assembly of oligonucleotides A, B, C, and D (each a construction oligonucleotide) into an A+B+C+D target may include assembling A+B and C+D oligonucleotides first (each a subconstruct or subassembly), then assembling the A+B and C+D subconstructs into an A+B+C+D (target) oligonucleotide. Sequential assembly may include assembling A+B (a primary subconstruct or subassembly), then A+B+C (a secondary subconstruct or subassembly), and finally A+B+C+D (target). One-step assembly combines A, B, C, and D in one reaction to produce the A+B+C+D target. It should be noted that different strategies can be mixed where a portion of the construction oligonucleotides are assembled using one strategy while another portion a different strategy.

The construction oligonucleotides can be chemically synthesized, e.g., on a solid support as described above. In some embodiments, the construction oligonucleotides can be synthesized in sufficient amount so as to enable direct subassembly or total assembly without the need to amplify one or more of the construction oligonucleotides. In certain embodiments, the construction oligonucleotides, after chemical synthesis, may be first subjected to subassembly into subconstructs, which can be amplified (e.g., in a polymerase based reaction) and then subjected to further assembly into secondary subconstructs or the final target. In some embodiments, one or more construction oligonucleotides can be amplified before assembly. In some embodiments, one or more subconstructs (or subassemblies) may be amplified before assembly. To that end, the construction oligonucleotides and/or subconstructs may be designed to have one or more universal or specific (e.g., unique) primer binding sites as disclosed herein.

Assembly can be performed on a solid support, optionally assisted by microfluidic devices such as those disclosed in PCT Publication Nos. WO2011/066185 and WO2011/056872, the disclosure of each of which is incorporated herein by reference in its entirety.

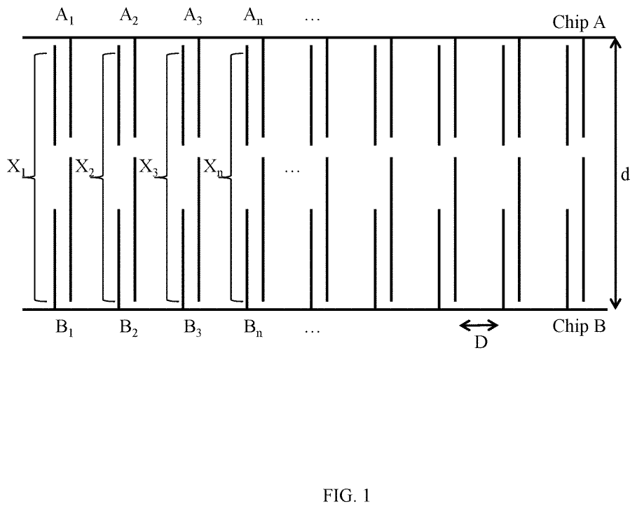

One solid support based assembly strategy is disclosed in PCT Publication No. WO2012/078312, incorporated herein by reference in its entirety. Briefly, in some embodiments, two or more chips can be designed for multiplex nucleic acid assembly. Each chip is designed to have a plurality of discrete, addressable features. For example, referring to FIG. 1, chip A is designed to have features A₁, A₂, A₃, . . . Aₙ, and chip B that has features B₁, B₂, B₃, . . . Bₙ. A₁ and B₁ have oligonucleotides immobilized thereon that together comprise target nucleic acid X₁, A₂ and B₂ have oligonucleotides immobilized thereon that together comprise target nucleic acid X₂, . . . , and Aₙ and Bₙ have oligonucleotides immobilized thereon that together comprise target nucleic acid Xₙ. More chips can be used for assembly of longer target nucleic acids. The features within a single chip are separated from one another by distance D (e.g., 10 microns, 15 microns, 20 microns, 25 microns, 30 microns, 35 microns, 40 microns, 45 microns, 50 microns, 55 microns, 60 microns, 65 microns, 70 microns, 75 microns, 80 microns, 85 microns, 90 microns, 95 microns, 100 microns, or any other suitable distance). During assembly, two chips (e.g., A and B) can be aligned to face each other so that feature A₁ aligns with feature B₁, feature A₂ aligns with feature B₂, . . . , and feature Aₙ aligns with feature Bₙ. The distance d between the two chips is sufficiently small such that the oligonucleotides within features A₁, A₂, A₃, . . . Aₙ can be in contact with those within features B₁, B₂, B₃, . . . Bₙ, respectively. For example, if on average the oligonucleotides are 100 bp long, d can be approximately 30 nanometers (3 nm/bp×100 bp). Distances D and d can be designed such that d<<D, to ensure that oligos in one chip contact those in another chip, without contacting oligos in adjacent features on the same chip. This way, oligonucleotides within features A₁, A₂, A₃, . . . , and Aₙ can be assembled with those within features B₁, B₂, B₃, . . . , and Bₙ by, e.g., ligation and/or polymerase based assembly. Thereafter, the assembled products X₁, X₂, X₃, . . . , and Xₙ can be released from one or both chips via, e.g., chemical, enzymatic, or light-activatable cleavage.

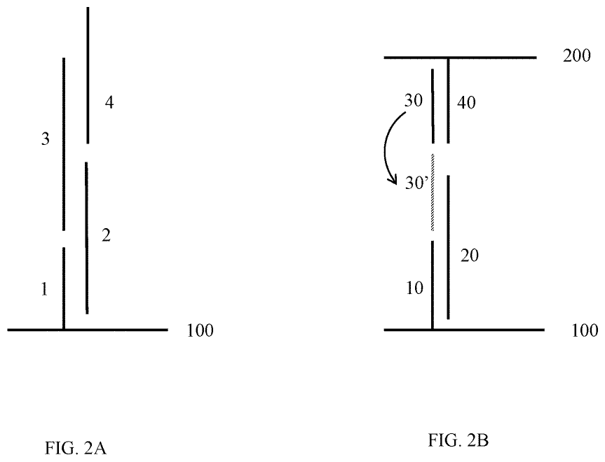

FIG. 2A illustrates an exemplary method for the assembly of an extended oligonucleotide at one feature. Each of oligonucleotides 1-4 represents a portion of the two strands of a target nucleic acid fragment to be assembled. Oligonucleotide 1 can be immobilized on a feature of an anchor chip 100. Oligonucleotides 2-4 can be brought into contact with oligonucleotide 1 via, e.g., piezoelectric based singulation as disclosed herein. Assembly can occur by the base pairing of the complementary portion of oligonucleotide 1 with oligonucleotide 2, base pairing of the complementary portion of oligonucleotide 2 with oligonucleotide 3, and base pairing of the complementary portion of oligonucleotide 3 with oligonucleotide 4. Using chain extension (to the extent there is any gap between 1 and 3 or 2 and 4) and/or ligation reactions, oligonucleotides 1-4 can be assembled into a double-stranded product. More oligonucleotides can be assembled using the same strategy, in a single one-pot reaction, or by serial addition.

FIG. 2B illustrates an exemplary method for the assembly of an extended oligonucleotide using two chips, anchor chip 100 and construction chip 200. Oligonucleotide 10 is immobilized on a feature of anchor chip 100. Oligonucleotide 20 is provided which partially anneals with oligonucleotide 10 and additionally contains a portion that has sequence complementarity with oligonucleotide 30. Oligonucleotide 30 can be synthesized on construction chip 200 in a polymerase based reaction and is complementary to or contains a portion that has sequence complementarity with oligonucleotide 40 that is immobilized on construction chip 200. After synthesis, oligonucleotide 30 can be released from construction chip 200 and be transferred to anchor chip 100 as construction oligonucleotide 30′. Construction oligonucleotide 30′ by design anneals with oligonucleotide 20 and thus, is brought into close proximity with oligonucleotide 10. Using chain extension (to the extent there is any gap between 10 and 30′) and/or ligation reactions, oligonucleotides 10, 20 and 30′ can be assembled into a double-stranded product Like construction oligonucleotide 30′, oligonucleotide 20 can also be provided from a construction chip that can be the same as, or different from, construction chip 200. More oligonucleotides can be assembled using the same strategy, in a single one-pot reaction, or by serial addition.

### Singulation

During any step of the oligonucleotide synthesis and multiplex nucleic acid assembly processes disclosed herein, it may be desirable to selectively expel and/or transfer one or more nucleic acid from the original location for further manipulation. For example, in some embodiments, the assembled X₁, X₂, X₃, . . . , and Xₙ target nucleic acids can remain attached to one chip (e.g., the anchor chip) where selective picking or singulation of one or more target nucleic acids can be performed. Alternatively, the target nucleic acids can be released from the chip but remain adsorbed within the addressable features (e.g., retained by microvolumes of solution) before selective singulation. Selective singulation may be desirable to select specific target nucleic acids of interest based on their location on the addressable features. In some embodiments, one or more target nucleic acids can be randomly picked for quality check purposes. For example, m number of target nucleic acids can be randomly picked out of the n features on the chip (e.g., m<<n) and subjected to sequencing to confirm the assembly quality.

One advantage of the singulation devices and methods disclosed herein is the contact-free ejection of selected nucleic acid, which avoids the need to replace pipette tips as may be used in a mechanical picking apparatus. This also minimizes potential cross contamination while providing the capability of large-scale ejection and selection of desirable nucleic acids.

In some embodiments, selective singulation can be achieved using a piezoelectric component. The piezoelectric component can be in the form of a board, a grid, or a matrix of piezoelectric elements, which can be placed above, underneath or as an integrated part of the solid support such that each piezoelectric element corresponds to a feature. The piezoelectric elements can be selectively activated by, e.g., passing an electric current through one or more elements, to generate a mechanical force to expel, transfer, or otherwise transport select target nucleic acids. The mechanical force can be controlled, e.g., to be strong enough to cleave the target nucleic acid at the cleavable linker by which it is attached to the chip. Alternatively, the target nucleic acid may have previously been released or may be simultaneously (concurrently) released via, e.g., chemical, enzymatic, and/or light-activatable cleavage, into a volume of nucleic acid (e.g., a microvolume of liquid solution), and the controllable mechanical force may be sufficient to expel, transfer, or otherwise transport the volume of nucleic acid. In some embodiments, a laser can be used to selectively release one or more target nucleic acids by cleaving light-activatable linkers.

The piezoelectric component can also be in the form of a single piezoelectric element (e.g., a nozzle or needle) that can be moved to a selected feature, to expel, transfer, or otherwise transport the target nucleic acid attached to the feature. In some embodiments, more than one element (e.g., two, three, four, five, six, seven, eight, nine, ten, eleven, twelve, thirteen, fourteen, fifteen, etc. elements) may be moved to a selected feature and may be used to expel, transfer, or otherwise transport the target nucleic acid attached to the feature at one time. In some embodiments, the features themselves can contain a piezoelectric material where an electric current can be selectively passed through one or more features (concurrently or at different times) to expel, transfer, or otherwise transport the target nucleic acids attached to the features.

In some embodiments, each feature on the chip can be configured to include a piezoelectric component such that an outer electrical field, when applied, stretches or compresses the piezoelectric component to cause the reagents (e.g., in an aqueous solution or in a dry environment) situated on the feature to move. The piezoelectric component can be the outer most layer in each feature, and can be optionally treated to have a surface chemistry that allows the deposition (depositing of) or immobilization of oligonucleotides. Alternatively, another layer of material (a surface material) can be placed on top of the piezoelectric component, and the surface material can be used to deposit or immobilize oligonucleotides. The outer electrical field can be uniformly applied to all features or selectively applied to one or more features of interest. Depending on the type of piezoelectric component, the outer electrical field, when applied, can stretch or compress the piezoelectric component, e.g., substantially perpendicularly to the reagents situated on the feature, to expel, transfer, or otherwise transport the reagents away from the feature. In some embodiments, two chips can be aligned such that the reagents expelled or transferred from the first chip can be transported to the second chip. The reagents can include one or more oligonucleotides for assembly, a volume of fluid that facilitates the transport of the oligonucleotides, as well as one or more of: ligase, dNTPs, DNA polymerase, restriction enzyme, and buffer/salts for the ligation, PCR and/or restriction reactions.

In some embodiments, a second piezoelectric component can be added to help expel, transfer, or otherwise transport the reagents, in addition to a first piezoelectric component contained within the chip. The second piezoelectric component can be in the form of a board, a grid, or a matrix of piezoelectric elements, which can be placed above or underneath the chip such that each piezoelectric element corresponds to a feature. Together, the first and second piezoelectric components direct the controlled movement of reagents on one or more features.

Suitable piezoelectric materials include natural materials such as Berlinite (AlPO₄), quartz, and Topaz; or man-made crystals such as Gallium orthophosphate (GaPO₄) or Langasite (La₃Ga₅SiO₁₄). Suitable manmade ceramics include Barium titanate (BaTiO₃), Lead titanate (PbTiO₃), Lead zirconate titanate, Lithium niobate (LiNbO₃), Lithium tantalite (LiTaO₃), and Sodium tungstate (Na₂WO₃). Some polymers such as polyvinylidene fluoride (PVDF) may also be suitable. One of skill in the art would be able to determine the types of piezoelectric materials suitable for use in the compositions and methods described herein.

These piezoelectric materials can be incorporated into a microelectromechanical system (MEMS) actuator to achieve nucleic acid singulation. In one embodiment, a piezoelectric layer can be fabricated on top of a cantilever, sandwiched between electrodes, and/or poled in the vertical direction. An electric field can be applied between top and bottom electrodes, parallel to polarization of the piezoelectric layer, which can develop a negative strain in the transverse direction while the rest of cantilever does not. As a result, the cantilever bends up. In another embodiment, the piezoelectric layer can be fabricated on top of a cantilever, under interdigitated electrodes. An electric field can be in the plane and the piezoelectric layer is poled in the plane. With E parallel to poling, the piezoelectric layer can develop a positive strain in the direction of its length such that the cantilever bends down. In either embodiment, the cantilever can be so positioned as to achieve nucleic acid ejection.

In some embodiments, comb drive actuators can also be used. Comb drive actuators typically contain two inter-digitated finger structures, where one comb is fixed and the other is connected to a compliant suspension. Typically the teeth are arranged so that they can slide past one another until each tooth occupies the slot in the opposite comb. The driving voltage across the piezoelectric material causes the deformation of truss material which further leads to displacement of the movable fingers towards the fixed fingers. Mechanical forces are generated through spring structure. The piezoelectric component can also be provided in the form of a slipstick, inchworm, and/or flipper, etc., as generally understood by one or ordinary skill in the MEMS art.

In certain embodiments, the piezoelectric material can be an integrated component of the solid support at each feature. The nucleic acids can be bound on the piezoelectric material. An optional flexible backing material can be included. The change in polarization in the piezoelectric material upon actuation can be used for concave or convex ejection.

In some embodiments, selective singulation can be achieved using an acoustic component. The acoustic component can be in the form of a board, a grid, or a matrix of acoustic elements, which can be placed above, underneath or as an integrated part of the solid support such that each acoustic element corresponds to a feature. The acoustic elements can be selectively activated, to generate a mechanical force to expel, transfer, or otherwise transport select target nucleic acids. The mechanical force can be controlled, e.g., to be strong enough to cleave the target nucleic acid at the cleavable linker by which it is attached to the chip. Alternatively, the target nucleic acid may have previously been released or may be simultaneously (concurrently) released via, e.g., chemical, enzymatic, and/or light-activatable cleavage, into a volume of nucleic acid (e.g., a microvolume of liquid solution), and the controllable mechanical force may be sufficient to expel, transfer, or otherwise transport the volume of nucleic acid. In some embodiments, a laser can be used to selectively release one or more target nucleic acids by cleaving light-activatable linkers.

In certain embodiments, selective singulation may be achieved by any method, including by a method in which a component is configured to interact with features and effectuate transfer of one or more volumes of nucleic acid through mechanical displacement. In some embodiments, selective singulation may be achieved without such mechanical displacement (e.g., through a method using components other than the piezoelectric or acoustic elements described herein). As a non-limiting example, one or more specific target nucleic acid(s) may have previously been released or may be simultaneously (concurrently) released from a solid support via, e.g., chemical, enzymatic, and/or light-activatable cleavage, into a volume of nucleic acid (e.g., a microvolume of liquid solution), and the solid support (e.g., microarray, chip, or microwell plate) may be positioned near another solid support such that the volume of nucleic acid forms a fluid chamber connecting one feature (addressable point) on one solid support with a feature on the second solid support (e.g., microarray, chip, or microwell plate). Such contact, with or without an additional mechanical force (e.g., such as that provided by a piezoelectric or acoustic element) may be sufficient to transfer or otherwise transport the volume of nucleic acid. In some embodiments, a laser can be used to selectively release one or more target nucleic acids by cleaving light-activatable linkers.

In another embodiment, the nucleic acids can be immobilized to microparticles or beads. One or more beads having the same nucleic acids can be placed in a single well on a multiwell plate. In some embodiments, each well is an addressable feature having a corresponding piezoelectric or acoustic element (or other component configured to interact with one or more features and effectuate transfer of one or more volumes of nucleic acid through mechanical displacement) that, upon actuation, can eject the beads located within that well. In this embodiment, the beads can be provided in a dry environment. In some embodiments, each well is an addressable feature that does not have a corresponding component configured to interact with one or more features and effectuate transfer of one or more volumes of nucleic acid through mechanical displacement (e.g., piezoelectric or acoustic element. In such embodiments, the multiwell plate may be positioned near another (second) multiwell plate or other solid support (e.g., a chip or a microarray) such that the volume of nucleic acid (e.g., in a liquid format) forms a fluid chamber connecting one feature (addressable point or microwell) on with a feature on the second solid support (e.g., microarray, chip, or microwell plate). Such contact, with or without an additional mechanical force (e.g., such as that provided by a piezoelectric or acoustic element or any other element which may effectuate transfer using mechanical displacement) may be sufficient to transfer or otherwise transport the volume of nucleic acid. Liquids can also be added to the wells to facilitate various reactions such as restriction digestion, chain extension and ligation.

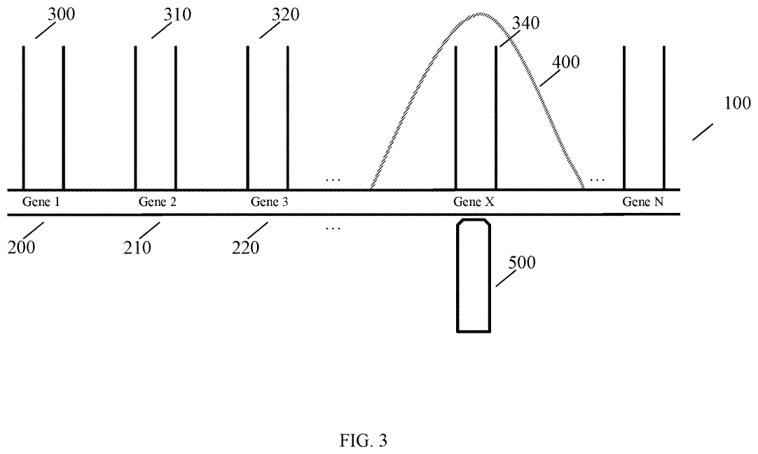

FIG. 3 illustrates an exemplary embodiment of methods and/or compositions described herein. Anchor chip 100 comprising a plurality of addressable features 200, 210, 220 . . . , etc., each comprising or attached to a plurality of assembled nucleic acids Gene 1 (300), Gene 2 (310), Gene 3 (320), Gene X (340), . . . , etc., is provided. Selective picking or singulation of one or more target nucleic acids such as Gene X (340) can be performed. The location of Gene X can be determined based on the address of each feature. A microvolume of solution 400 can be deposited, which can comprise desirable reagents to achieve chemical, enzymatic, or light-activatable cleavage of target nucleic acid 340. Once cleaved and released into solution 400, target nucleic acid 340 can then be selectively expelled, transferred, or otherwise transported by piezoelectric element 500. In some embodiments, piezoelectric element 500 may be replaced with an acoustic element or other suitable component that is configured to interact with one or more features and effectuate transfer through mechanical displacement. In certain embodiments, no piezoelectric element or acoustic element or other component configured to interact with one or more features and effectuate transfer through mechanical displacement is required for the transport of the target nucleic acid (i.e., element 500 is not present).

It should be noted that selective picking or singulation can be performed after complete assembly, and/or during assembly where one or more subconstructs can be picked for further manipulation such as amplification, sequencing, and/or further assembly. In addition, construction oligonucleotides, prior to assembly, can also be selectively picked (e.g., selected or chosen) for amplification, sequencing, and/or assembly.

### Droplet-Based Assembly

In some embodiments, selective picking or singulation as disclosed herein can be used to manipulate droplets, e.g., transferring one or more droplets from one feature to another, and/or from one solid support to another. Droplet formation and uses thereof are disclosed in, e.g., International Publication Nos. WO2010/025310, WO2011/056872, WO2011/066186; and U.S. Pat. Nos. 8,716,467 and 9,295,965, the entirety of each of which is incorporated by reference herein.

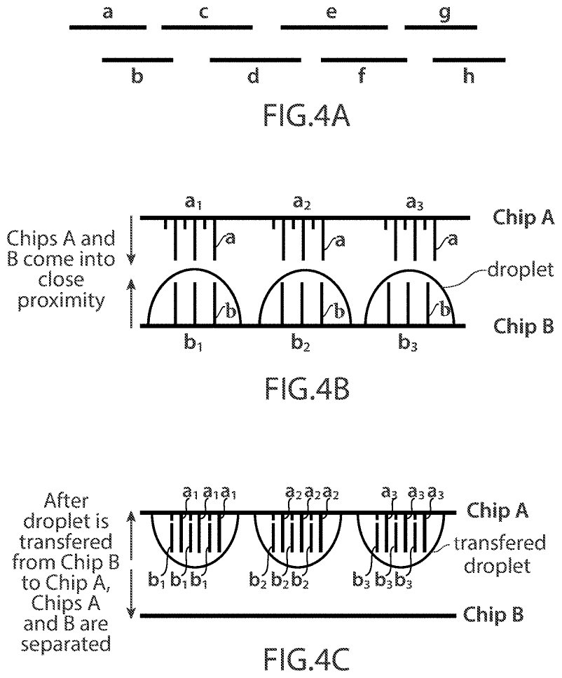

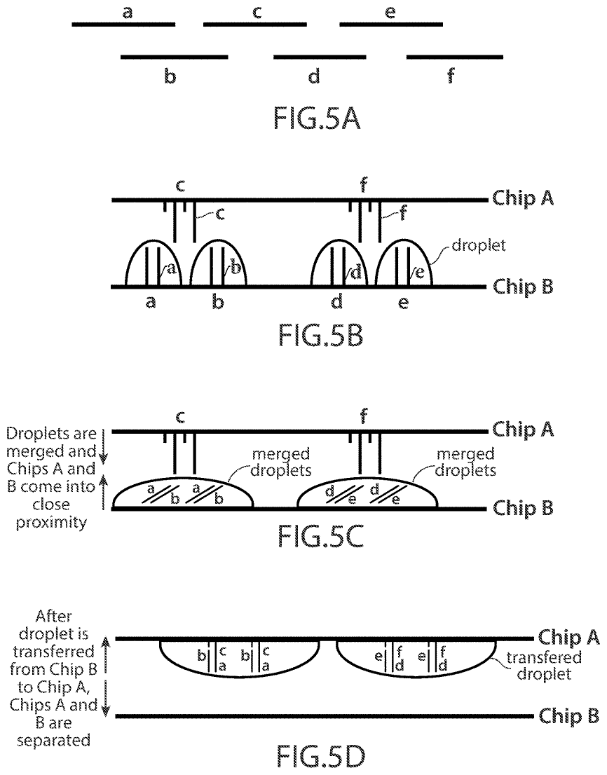

FIGS. 4 and 5 illustrate embodiments of droplet-based assembly on solid supports such as chips. Fragments of parsed complementary strands of an exemplary target nucleic acid are depicted as construction fragments a-h in FIG. 4, part A. More or fewer construction fragments can be designed depending on the target nucleic acid (e.g., depending on the complexity and/or length of the target nucleic acid). Multiple copies of Fragment a are immobilized at one or more features such as a1, a2, and a3 on Chip A, and multiple copies of Fragment b are immobilized at one or more features such as b 1, b2, and b3 on Chip B. Each feature on Chip B can be covered by a droplet of solution as shown in FIG. 4, part B. According to one embodiment of the invention, Fragment b is cleaved, decoupled, or otherwise becomes unbound from the surface of one or more features on Chip B and released into the droplet. Chips A and B are aligned such that Features a1-a3 oppose Features b1-b3. Chips A and B are brought into close proximity such that the droplets covering Features b1-b3 are transferred from Chip B to cover Features a1-a3 on Chip A, transporting the unbound copies of Fragment b to Features a1-a3. According to one embodiment, the transfer of the droplets may be accomplished by any means, including but not limited to, vibration or ejection actuated by a piezoelectric component as disclosed herein, sonic or ultrasonic vibration, or other kinetic measures. Other methods for effecting the transfer of the droplets may comprise the use of electro-wetting technology or other electronic measures. Alternatively or additionally, modulating or controlling the hydrophilicity and/or hydrophobicity of the features or surrounding surface areas on Chips A and/or B, or the size or shape of the features may be used to effect the transfer of the droplets from Chip B to A.

In FIG. 4, part C, Chips A and B are separated, with the transferred droplets now covering Features a1-a3 on Chip A. The features are subjected to conditions suitable for hybridization of Fragment b to the immobilized Fragment a. In certain embodiments, the fragments have been parsed such that, for example, upon hybridization, the Fragment a/b duplex comprises a single-stranded overhang on the unbound terminus. This process can be repeated with Features a1-a3 aligned with features comprising multiple copies of Fragment c, and then repeated with features comprising multiple copies of Fragment d, and so forth such that the target nucleic acid is assembled in a serial fashion. Alternatively or additionally, the target nucleic acid may be assembled in hierarchical fashion by bringing Fragments a and b together in one feature and Fragments c and d together in another feature, and so forth (forming Fragment a/b and Fragment c/d, respectively), and then bringing the Fragment a/b duplexes together with the Fragment c/d duplexes. This may be followed by bringing the assembled Fragment ac/bd duplexes together with a similarly assembled Fragment eg/fh duplexes. Such assembly may be repeated iteratively until the target (i.e., the target oligonucleotide) is synthesized.

In FIG. 5, part A, fragments of parsed complementary strands of a target nucleic acid are depicted as Fragments a-f. On Chip A, multiple copies of Fragments c and f are immobilized at Features c and f, respectively. On Chip B, multiple copies of Fragments a, b, d and e are immobilized at Features a, b, d, and e, respectively. Each feature on Chip B is covered by a droplet of solution as shown in FIG. 5, part B. According to one embodiment of the invention, Fragments a, b, d, and e are cleaved, decoupled, or otherwise become unbound from the surface of each feature on Chip B and are released into the droplet at each respective feature. On Chip B, the droplets at Features a and b are merged into a single droplet, as are the droplets at Features d and e. The merged droplets are subjected to conditions suitable for hybridization of Fragments a and b in one merged droplet, and Fragments d and e in the other merged droplet, respectively forming Fragment a/b and Fragment d/e. In certain embodiments, the fragments have been parsed such that, upon hybridization, for example, the Fragment a/b comprises a single-stranded overhang on the unbound terminus, and that single-stranded overhang is complementary to a portion of Fragment c. As shown in FIG. 5, part C, Chips A and B are then aligned such that Features a/b are opposite to Feature c, and Features d/e are opposite Feature f. Chips A and B are brought into close proximity such that the merged droplet covering Features a/b is transferred from Chip B to cover Feature c on Chip A, transporting the unbound copies of Fragment a/b duplexes to Features c; the merged droplet covering Features d/e is transferred from Chip B to cover Feature f on Chip A, transporting the unbound copies of Fragment d/e duplexes to Features f. The droplets are subjected again to conditions suitable for hybridization such that the single-stranded overhang of the Fragment a/b duplex hybridizes with Fragment c, and the single-stranded overhang of the Fragment d/e duplex hybridizes with Fragment f. According to one embodiment, the transfer of the droplets may be accomplished by any means, including but not limited, vibration actuated by piezoelectric materials, sonic or ultrasonic vibration, or other kinetic measures. Other methods for effecting the transfer of the droplets may comprise the use of electro-wetting technology or other electronic measures. Alternatively or additionally, modulating or controlling the hydrophilicity and/or hydrophobicity of the features or surrounding surface areas on Chips A and/or B, or the size or shape of the features may be used to effect the transfer of the droplets from Chip B to A. In FIG. 5, part D, Chips A and B are separated, with the transferred droplets now covering Features c and f on Chip A. This process can be repeated so as to assemble the target nucleic acid in a serial and/or hierarchical fashion.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Also, the phraseology and terminology used herein is for the purpose of description and should not be regarded as limiting.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for the use of the ordinal term) to distinguish the claim elements.

### INCORPORATION BY REFERENCE

All publications, patents and sequence database entries mentioned herein are hereby incorporated by reference in their entireties as if each individual publication or patent was specifically and individually indicated to be incorporated by reference. Reference is made in particular to International Publication Nos. WO2010/025310, WO2011/056872, WO2011/066186; and U.S. Pat. Nos. 8,716,467 and 9,295,965, the entirety of each of which is incorporated by reference herein.

1. A device for selectively expelling nucleic acids, comprising:
a) a piezoelectric component configured to align with one or more features on a solid support, such that when in use, the piezoelectric component generates a mechanical force to selectively expel one or more volumes of nucleic acid from the solid support, wherein the solid support comprises a plurality of discrete features, each feature being associated with a volume of nucleic acid; and
b) a power source for providing an electric current to the piezoelectric component to generate the mechanical force.

2. A device for selectively expelling nucleic acids, comprising:
a) a solid support comprising a plurality of discrete features, each feature being associated with a volume of nucleic acid;
b) a piezoelectric component configured to selectively expel one or more volumes of nucleic acid from the solid support; and
c) a power source for providing an electric current to the piezoelectric component to generate a mechanical force to expel the one or more volumes of nucleic acid.

3. The device of claim 1 or 2, wherein each volume of nucleic acid comprises one or more oligonucleotides.

4. The device of claim 3, wherein the one or more oligonucleotides are in a dry environment or liquid environment.

5. The device of claim 3, wherein each volume of nucleic acid is a droplet of solution.

6. The device of claim 1 or 2, wherein each feature has a plurality of oligonucleotides immobilized thereon.

7. The device of claim 1 or 2, wherein the solid support is a microarray or a multiwell plate comprising a plurality of beads.

8. The device of claim 1 or 2, wherein the piezoelectric component comprises a matrix of piezoelectric elements, each piezoelectric element configured to correspond to a feature.

9. The device of claim 3, wherein the one or more oligonucleotides are released into the volume of nucleic acid via chemical, enzymatic, and/or laser cleavage.

10. The device of claim 9, further comprising a laser for selectively releasing the one or more oligonucleotides into the volume of nucleic acid by cleaving light-activatable linkers.

11. The device of claim 1 or 2, wherein the piezoelectric component comprises a single piezoelectric element.

12. The device of claim 11, wherein the single piezoelectric element is a needle.

13. The device of claim 12, further comprising a transport component configured to move the needle to a desired feature.

14. A method of nucleic acid assembly, comprising:
a) providing a first solid support comprising a plurality of discrete features, each feature being associated with a volume of nucleic acid;
b) selectively expelling, using a piezoelectric component, one or more volumes of nucleic acid from a first feature to a second feature, wherein the first feature comprises a first oligonucleotide having sequence complementarity or overlap with a second oligonucleotide in the second feature; and
c) assembling the first and second oligonucleotides.

15. The method of claim 14, wherein the piezoelectric component comprises a matrix of piezoelectric elements, each piezoelectric element configured to correspond to a feature.

16. The method of claim 14, wherein each volume of nucleic acid comprises one or more oligonucleotides.

17. The method of claim 16, wherein the one or more oligonucleotides are in a dry environment or liquid environment.

18. The method of claim 16, further comprising releasing the one or more oligonucleotides into the volume of nucleic acid via chemical, enzymatic, and/or laser cleavage.

19. The method of claim 14, wherein the solid support is a microarray or a multiwell plate comprising a plurality of beads.

20. The method of claim 14, wherein each feature has a plurality of oligonucleotides immobilized thereon.

21. The method of claim 14, wherein the first feature and the second feature are located on the same solid support.

22. The method of claim 14, wherein the first feature is located on the first solid support and the second feature is located on a second solid support.

23. A device for selectively expelling nucleic acids, comprising:
a) a component configured to align with one or more features on a solid support, such that when in use, the component generates a mechanical force to selectively expel one or more volumes of nucleic acid from the solid support, wherein the solid support comprises a plurality of discrete features, each feature being associated with a volume of nucleic acid; and
b) a power source for providing an electric current to the component to generate the mechanical force.

24. A device for selectively expelling nucleic acids, comprising:
a) a solid support comprising a plurality of discrete features, each feature being associated with a volume of nucleic acid;
b) a component configured to selectively expel one or more volumes of nucleic acid from the solid support; and
c) a power source for providing an electric current to the component to generate a mechanical force to expel the one or more volumes of nucleic acid.

25. The device of claim 23 or 24, wherein the component is an acoustic component or a piezoelectric component.

26. The device of claim 23 or 24, wherein each volume of nucleic acid comprises one or more oligonucleotides.

27. The device of claim 26, wherein the one or more oligonucleotides are in a dry environment or liquid environment.

28. The device of claim 26, wherein each volume of nucleic acid is a droplet of solution.

29. The device of claim 23 or 24, wherein each feature has a plurality of oligonucleotides immobilized thereon.

30. The device of claim 23 or 24, wherein the solid support is a microarray or a multiwell plate comprising a plurality of beads.

31. The device of claim 23 or 24, wherein the component comprises a matrix of elements, each element configured to correspond to a feature.

32. The device of claim 26, wherein the one or more oligonucleotides are released into the volume of nucleic acid via chemical, enzymatic, and/or laser cleavage.

33. The device of claim 32, further comprising a laser for selectively releasing the one or more oligonucleotides into the volume of nucleic acid by cleaving light-activatable linkers.

34. The device of claim 23 or 24, wherein the component comprises a single element.

35. The device of claim 34, wherein the single element is a needle.

36. The device of claim 35, further comprising a transport component configured to move the needle to a desired feature.

37. A method of nucleic acid assembly, comprising:
a) providing a first solid support comprising a plurality of discrete features, each feature being associated with a volume of nucleic acid;
b) selectively expelling, using a component, one or more volumes of nucleic acid from a first feature to a second feature, wherein the first feature comprises a first oligonucleotide having sequence complementarity or overlap with a second oligonucleotide in the second feature; and
c) assembling the first and second oligonucleotides.

38. The device of claim 37, wherein the component is an acoustic component or a piezoelectric component.

39. The method of claim 37, wherein the component comprises a matrix of elements, each element configured to correspond to a feature.

40. The method of claim 37, wherein each volume of nucleic acid comprises one or more oligonucleotides.

41. The method of claim 40, wherein the one or more oligonucleotides are in a dry environment or liquid environment.

42. The method of claim 40, further comprising releasing the one or more oligonucleotides into the volume of nucleic acid via chemical, enzymatic, and/or laser cleavage.

43. The method of claim 37, wherein the solid support is a microarray or a multiwell plate comprising a plurality of beads.

44. The method of claim 37, wherein each feature has a plurality of oligonucleotides immobilized thereon.

45. The method of claim 37, wherein the first feature and the second feature are located on the same solid support.

46. The method of claim 37, wherein the first feature is located on the first solid support and the second feature is located on a second solid support.

47. A method of nucleic acid assembly, comprising:
a) providing a first solid support comprising a plurality of discrete features, each feature being associated with a volume of nucleic acid;
b) selectively transferring one or more volumes of nucleic acid from a first feature to a second feature, wherein the first feature comprises a first oligonucleotide having sequence complementarity or overlap with a second oligonucleotide in the second feature; and
c) assembling the first and second oligonucleotides.

48. The method of claim 47, wherein each volume of nucleic acid comprises one or more oligonucleotides.

49. The method of claim 48, wherein the one or more oligonucleotides are in a dry environment or liquid environment.

50. The method of claim 48, further comprising releasing the one or more oligonucleotides into the volume of nucleic acid via chemical, enzymatic, and/or laser cleavage.

51. The method of claim 47, wherein the solid support is a microarray or a multiwell plate comprising a plurality of beads.

52. The method of claim 47, wherein each feature has a plurality of oligonucleotides immobilized thereon.

53. The method of claim 47, wherein the first feature and the second feature are located on the same solid support.

54. The method of claim 47, wherein the first feature is located on the first solid support and the second feature is located on a second solid support.
